(19) United States
(12) Patent Application Publication
(10) Pub. No.: US 2014/0282543 A1
(43) Pub. Date: Sep. 18, 2014

(54) SECURE ZONE ON A VIRUTAL MACHINE FOR DIGITAL COMMUNICATIONS

(71) Applicant: OLogN Technologies AG, Triesen/FL (LI)

(72) Inventors: Sergey IGNATCHENKO, Innsbruck (AT); Dmitri LIGOUM, Aurora (CA)

(73) Assignee: OLogN Technologies AG, Triesen/FL (LI)

(21) Appl. No.: 14/212,818

(22) Filed: Mar. 14, 2014

Related U.S. Application Data
(60) Provisional application No. 61/791,632, filed on Mar. 15, 2013.

(51) Int. Cl. G06F 9/455

(52) U.S. Cl. CPC G06F 9/45533
USPC 718/1

(57) ABSTRACT

An apparatus implementing a secure zone on one or more virtual machines may be provided. In one aspect, the apparatus may comprise a screen and a computer processor. The computer processor may be configured to initialize a hypervisor, establish a first virtual machine under the control of the hypervisor and execute code for a secure zone thereon, and establish a second virtual machine under the control of the hypervisor and execute code for a non-secure zone thereon. The code for the secure zone may be configured to initiate executing a task, and to assume control over an output to the screen while the apparatus is operating in a secure mode and to transfer control over the output to the non-secure zone while the apparatus is operating in a non-secure mode. The hypervisor may be configured to grant requests from the secure zone to assume and transfer control over the output.

### RELATED APPLICATIONS

This application claims priority to U.S. Provisional Application No. 61/791,632, filed Mar. 15, 2013, entitled “SECURE ZONE ON A VIRTUAL MACHINE FOR DIGITAL COMMUNICATIONS,” the content of which is incorporated herein by reference in its entirety.

### FIELD OF THE DISCLOSURE

The systems, methods and apparatuses described herein relate to the security of computer systems, and in particular, sensitive tasks related to commercial and other data transactions.

### BACKGROUND

Internet shopping, online banking, and other network-based forms of transmitting sensitive data are highly popular, but may be susceptible to a variety of security breaches resulting from computer viruses, backdoors, keyloggers and other forms of attacks on the user's computer or other device. These attacks generally relate to vulnerabilities in the operating system of the device used to access the network. Existing solutions either rely on software alone (such as anti-virus software) or limited hardware support of storing cryptographic keys using a secure cryptoprocessor (such as the Trusted Platform Module (TPM)). Neither separates the sensitive tasks from the non-sensitive tasks in order to provide heightened security protection to the sensitive tasks. What is needed is a suitable computing environment to implement security solutions that separates the sensitive tasks from the non-sensitive tasks, and in particular, take advantage of virtual machine technologies to provide separate computing resources to sensitive tasks and non-sensitive tasks.

### BRIEF DESCRIPTION OF THE DRAWINGS

FIG. 1 is a block diagram of an exemplary system according to the present disclosure.

FIG. 2 is a flow diagram illustrating an exemplary method by which a system according to the current disclosure may accept a task for execution; organize the process of task execution; and cleanup after task execution.

FIG. 3 is a block diagram of an exemplary processor according to the present disclosure.

FIG. 4A is a block diagram of an exemplary processor in operation according to the present disclosure.

FIG. 4B is a mapping of some of the components of the implementation of FIG. 1 to the components of the implementation of FIG. 4A according to the present disclosure

FIG. 5 is a flow diagram showing an exemplary process of initializing an exemplary processor according to the present disclosure.

FIG. 6 is a flow diagram showing an exemplary process of executing a task using an exemplary processor according to the present disclosure.

FIG. 7 is a flow diagram showing an exemplary process of executing a subtask using an exemplary processor according to the present disclosure.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

The present disclosure provides systems, methods and apparatuses for securely performing computer-based actions or transactions. For example, it might be desirable to use a computer to establish a secure connection with another user, for example, as a secure text-based chat session, or a secure phone call. In another example, it might be desirable to make a purchase over the Internet. In each case, a skilled individual could intercept the data within an operating system running the computer—e.g., even if a chat conversation is encrypted before it is transmitted from one computer to another, each text message could be intercepted within the operating system before it enters the encrypted channel, or payment information could be intercepted and/or modified after it is decrypted—by, for example, installing malware (such as a virus, a keylogger or a Trojan horse) into the operating system of the user's computer. The inventions described herein provide a way to transfer certain activities to a secure zone, which cannot be compromised even if the operating system is under complete control of the attacker, so as to ensure that these computer-based activities truly remain secure from attack.

In one non-limiting example, a computer processor according to the present disclosure may have a hypervisor to initialize and monitor execution of a plurality of virtual machines. The hypervisor may initialize and monitor a secure zone implemented in one or more virtual machines on the computer processor and a non-secure zone, such as a regular operating system, implemented on a separate virtual machine. The secure zone may have a supervisor in one virtual machine and communicate with the non-secure zone via an interface based, for example, on a memory block allocated by the hypervisor for the communication between the secure zone and non-secure zone. In some embodiments, the virtual machine for the secure zone may also execute secure tasks. In some other embodiments, each secure task may be executed on a separate virtual machine. In yet other embodiments, the hypervisor may implement some or all functionality of the supervisor. In some embodiments, the supervisor may be created on demand. That is, the supervisor may be initialized and executed only if there are secure tasks that need to be executed.

FIG. 1 shows one example by which a secure zone 150 according to the present disclosure may be implemented in a larger device 120, such as a computer, laptop, smart phone, television set, personal music player, set-top box, etc. One exemplary implementation of a computing device having a secure zone is disclosed in U.S. Provisional Patent Application No. 61/623,861, entitled “Secure Zone for Digital Communications,” and filed on Apr. 13, 2012, the entirety of which is incorporated herein by reference.

A secure zone 150 according to the present disclosure may first comprise an interface 151 to one or more non-secure zones 152. The term “non-secure zone,” as used herein, refers to any device, processor, operating system, or other object, or combination thereof, which is capable of providing messages, codes, tasks or other information to a secure zone 150. The interface 151 may be configured to receive these messages, codes or tasks from those non-secure zones 152. Exemplary techniques of implementing the interface 151 are described herein.

A secure zone 150 may further comprise a supervisor 160 coupled to the interface 151. The supervisor 160 may be used to control access to the components of the secure zone 150, and may be used to enforce certain operational rules of the secure zone 150, providing certain security assurances to the end-user. For example, in one embodiment, the supervisor 160 may be configured to: (1) receive executable code which can be run on one or more secure processors 162 within the secure zone 150 via the interface 151; (2) check that certain requirements (as described in greater detail below) are fulfilled for this code; (3) if requirements are fulfilled, load this code into one or more instruction memories 164 located within the secure zone 150; (4) clear one or more data memories 165 located within the secure zone 150; (5) instruct the secure processor 162 to execute code loaded into the instruction memory 164; (6) control one or more indicators 193, which may be used to signal to a user that the secure zone 150 has assumed control of the computing device 120; (7) control one or more peripherals within the computing device 120; (8) provide visual feedback to the end-user about the origin of the loaded code and (9) clean up (to the extent required) after the code has been executed. Each of these functions are described in greater detail below.

The secure zone 150 may also comprise a secure processor 162, an instruction memory 164 and a data memory 165. The secure processor 162 may be configured to execute code loaded into the instruction memory 164 and to exchange data with the non-secure zone 152 through the interface 151. In addition, it will be understood that while FIG. 1 shows the secure processor 162 as having a so-called “Harvard architecture” (with separate instruction memory 164 and data memory 165), other architectures (like the ubiquitous von Neumann architecture) may be used as long as equivalent instruction and data restrictions are enforced by the supervisor 160. By way of example and not limitation, the XN bit may be used in ARM® processors to provide some separation of data memory from instruction memory, as long as the XN bit in appropriate memory areas is enforced by the supervisor 160 and cannot be altered by code running on the secure processor 162. Similar separation may be achieved on x86 architecture by using the NX bit (also known as the XD bit on INTEL® CPUs and as Enhanced Virus Protection on AMD® CPUs).

In certain embodiments, the secure zone 150 may further comprise one or more cryptographic engines represented by a cryptographic engine 121 shown in FIG. 1. The cryptographic engine 121 may be configured to implement one or more symmetric and/or asymmetric cryptographic algorithms, such as Advances Encryption Standard (AES) algorithm, the Rivest-Shamir-Adleman (RSA) algorithm or any other existing or future-developed cryptographic algorithm. The cryptographic engine 121 may receive data from the supervisor 160 for encryption or decryption, and may provide the resulting ciphertext (or plaintext, as appropriate) back to the supervisor 160. In some embodiments, the cryptographic engine 121 also may be used by the secure processor 162; in this case, it may be desirable to have a clear separation between any cryptography-related tasks coming from the supervisor 160 to the crypto engine 121 and any cryptography-related tasks coming from the secure processor 162 to the crypto engine 121, so as to avoid any leaks of information associated with one component to the other. The secure zone 150 may also comprise a random number generator (RNG) 124 to provide support to cryptographic processes. In other embodiments, the supervisor 160 and/or the secure processor 162 may be configured to perform some or all of the functionality of the cryptographic engine 121 and/or random number generator 124, and a separate cryptographic engine 121 or RNG 124 may not be required.

If the secure zone 150 is expected to perform image and/or video processing, it may further comprise a decoder 122. For example, if the secure zone 150 receives encrypted media content from the non-secure zone 152 (such as from a video player application 112 running within the operating system 111), the code running on the secure processor 162 (with or without the help of the cryptographic engine 121, depending on the embodiment) might be responsible for decrypting the content, and then the decoder 122 may be responsible for decoding the content. This decoder 122 may comprise, for example, implementations of algorithms such as H.264, VC-1, PNG, JPEG, etc. In some cases, the decoder 122 may also include certain text rendering capabilities.

As shown on FIG. 1, the decoder 122 may be coupled to the secure processor 162, such that decrypted data may pass from the cryptographic engine 121 to the decoder 122. In other embodiments, the secure processor 162 may be configured to perform some or all of the functionality of the decoder 122, and a separate decoder may not be required. In still other embodiments, the secure zone 150 may not provide native support for image and/or video decoding, but may be able to receive and execute code (on the secure processor 162) designed to implement this type of media content processing.

In some embodiments, the instruction memory 164 and data memory 165 may be implemented as volatile memory. The absence of persistent writable storage for executable code may ensure that no viruses, back-doors, or other malicious code may be installed within the secure zone 150. In addition, the secure zone 150 may contain one or more certificate storages, represented by a certificate storage 166 shown in FIG. 1, which may be implemented as read-only, non-volatile memory. The certificate storage 166 may store one or more root certificates of one or more Certification Authorities (CA), which, in turn, may be used for certificate validation. The secure zone 150 may additionally comprise one or more key storages represented by a key storage 167 in FIG. 1. The key storage 167 may be implemented, for example, as non-volatile memory and may be used, for example, for the storage of one or more private keys (which can be generated, for example, by the supervisor 160 using RNG 124), one or more corresponding public key(s) or associated digital certificates, and/or a unique device identifier. This information may be used, among other uses, to identify and/or authenticate the computer-based device 120 within which the secure zone 150 is located.

As noted previously, a secure zone 150 is meant to be used within the context of a larger computer-based device 120, such as a television or a laptop. Thus, it will be understood that the computer-based device 120 may comprise a number of components which are outside the secure zone 150, but may nonetheless assist in the operation of the secure zone 150. For example, the device 120 may comprise traditional input/output devices such as a keyboard 192 or a screen 123. In other embodiments, the device 120 may further comprise other I/O devices (such as a mouse, remote control transceivers, speakers, or cameras). These I/O devices may be beneficial to the operation of the secure zone 150 when, for example, a user desires to type a secure text message without the risk of the operating system 111 eavesdropping or modifying it. The device 120 may further comprise a communications port 118, enabling the device to communicate with other devices. In the foregoing example, the communications port 118 may be useful in creating a connection between the device 120 and a remote computer over a network connection. Also, such a computer-based device 120 may run an operating system 111 and one or more applications 112.

Finally, as shown on FIG. 1, the device 120 also may comprise a means for indicating when the device 120 is operating in secure mode, shown on FIG. 1 as “indicator” 193. Such an indicator 193 may be, for example, a green LED which is placed on an outside case of the device 120 and readily visible to a user.

As a result, a device 120 according to the present disclosure may further comprise additional hardware, software or combination of both allowing it take control of these peripheral components of the device 120 from, e.g., the operating system 111. For example, the secure device 120 may comprise a mixer 181, allowing the secure zone 150 to control the screen 123. The device 120 might also comprise a keyboard switch 194, allowing the secure zone 150 to control the keyboard 192. In this manner, the same input/output devices (e.g., the keyboard 192 and screen 123) may be used to support both non-secure and secure zones. It shall be understood that while FIG. 1 shows components like the mixer 181 and the keyboard switch 194 as implemented outside of the secure zone 150, in some embodiments these components may be placed within the secure zone 150.

FIG. 2 shows an exemplary method by which a secure zone 150 according to the present disclosure may accept a task for execution; organize the process of task execution; and cleanup after task execution.

At step 205, the interface 151 may receive the code from the non-secure zone 152, and may pass this code to the supervisor 160 for execution by the secure processor 162. It should be understood that whenever code is transferred at step 205, the code may additionally include related application data.

At step 210, prior to executing any received code, the supervisor 160 may clear all data stored within the instruction memory 164 and data memory 165. For example, the supervisor 160 might zero all of the instruction memory 164 and data memory 165. This may be performed to prevent old code, data, or both, from affecting the code currently being loaded, and to avoid information leaks between different pieces of code.

In some embodiments, the code provider may have encrypted the code (and any related application data) before sending it to the secure zone 150. For example, the code provider may have used a public key corresponding to a private key of the supervisor 160 (which may previously have been stored in the key storage 167, and which may be used by the supervisor 160 to decrypt the code) to encrypt the code. Thus, at step 215, if the code has been encrypted using a public key of the supervisor 160, the supervisor 160 may extract a copy of the corresponding private key from key storage 167 and direct the cryptographic engine 121 to decrypt the code (and any associated data, if applicable) using this private key.

In addition, the code (and any related data) also may have been digitally signed using the code provider's private key, guaranteeing the authenticity of the code. To enable validation of the digital signature and the signed code, a digital certificate capable of authenticating the code provider may be provided with the code. For example, the code provider may have a private key and a corresponding digital certificate which has been signed by a “root certificate” of a certificate authority. In such an implementation, the root certificate previously may have been stored in the certificate storage 166. In some embodiments, instead of a single certificate, whole “certificate chains” may be included with the code. In other embodiments, alternative ways of obtaining intermediate certificates (for example, issuing a request to a server (not shown) via the operating system OS 111 and communications port 118) may be used.

At step 220, the supervisor 160 may instruct the cryptographic engine 121 to validate the digital signature of the code provider. This validation of the digital signature will usually include validation of the certificate received with the code. For example, if the code provider's certificate were signed by a certificate authority such as VeriSign®, the supervisor 160 may take a copy of the appropriate VeriSign root certificate from the certificate storage 166 and verify that this root certificate was used to sign the code provider's certificate, performing a typical public key infrastructure (PKI) signature validation; in some cases, a more elaborate validation (for example, including “certificate chains”) may be implemented.

In some embodiments, other signature validation schemas (for example, those used in the simple public key infrastructure (SPKI)/simple distributed security infrastructure (SDSI) or the “web of trust” used in pretty good privacy (PGP)) may be used.

In some embodiments, the supervisor 160 may additionally perform certificate revocation list (CRL) validation to ensure that all certificates involved in the signature validation are still valid. CRL can be obtained, for example, by means of a request to a server which hosts CRLs. This request can be made, for example, via the operating system 111 and the communications port 118 of the non-secure zone 152.

In some embodiments, the Online Certificate Status Protocol (OCSP) may be used to check certificate validity (instead of or in addition to CRL validation).

In certain embodiments, the code provider's digital certificate may differ slightly from a traditional certificate, such that it contains not only a text entry capable of identifying the certificate owner (usually the “CN” field of an X.509 digital certificate), indicating the name of the code provider associated with the certificate, but may further contain an image (for example, PNG or JPEG) with a visual representation of the identity of the code provider, as described U.S. Provisional Application 61/623,861.

At step 225, the supervisor 160 may take control of one or more peripherals of the computing device 120 that it needs in order to execute the received code. For example, the supervisor 160 may take control of the keyboard 192 and the screen 123 of the laptop. In such a case, the supervisor 160 may instruct the keyboard switch 194 to effectively disconnect the keyboard 192 from the non-secure components (such as the operating system 111) and to route all keyboard input to the secure zone 150. The supervisor 160 may also instruct the mixer 181 to combine output from image processor 171 and decoder 122 to form image on screen 123, effectively disconnecting the non-secure zone from the screen 123.

In some embodiments, it may be desirable to provide one or more affirmative confirmations to the user that the device 120 is now operating in a partial-screen secure mode. Thus, at step 235, the supervisor 160 may provide the “identity image” from the code provider's certificate (which certificate has been validated in step 220) to the image processor 171, and may instruct the mixer 181 to show information from the image processor 171 on a designated area of the screen 123. At step 240, the supervisor 160 may turn on the indicator 193.

In such embodiments, the user may confirm that the task is running in the secure zone 150 by checking that the indicator 193 is on, and may confirm that the task was received from a legitimate code provider by verifying that the information displayed in the designated area of the screen 123 (e.g., the code provider's certificate identity image) corresponds to the user's expectations for this task.

If, for example, the information displayed on the screen 123 does not match the user's expectations—e.g., the code provider's name is incorrect, or the wrong identity image is displayed—the user may take an appropriate action to halt the task. For example, in some embodiments, the user could press a special key combination on the keyboard 192 to instruct the supervisor 160 to terminate the secure session. Alternatively, if the information displayed on the screen 123 does match the user's expectations but the indicator 193 is off (which may happen, for example, if the operating system 111 is compromised and an attacker controlling the operating system 111 simulates screen output without relegating control to the secure zone 150), the user may similarly take any appropriate action to halt the task. Thus, in order for the user to be assured he is working in a completely secure environment, both (i) the identity image should be displayed in the designated area of screen 123 and (ii) the indicator 193 should be on.

In certain embodiments, the code provider may decide that the task does not require provision of a fully secure environment to the user, but rather requires access to the full area of the screen 123 (i.e., “full-screen secure mode”). This may be implemented, for example, by setting a boolean flag, indicating whether to use full-screen or partial-screen (i.e., displaying the identity image) mode; to ensure security, supervisor 160 may ensure that indicator 193 is on only in partial-screen secure mode (i.e., when the identity image is displayed) If, at step 230, it is determined that the task should run in full-screen secure mode, the supervisor 160 may grant the secure processor 162 access to the whole screen 123 and proceed to step 245. Full-screen mode might be useful, for example, if the user simply wishes to decrypt and display protected media content he already possesses—the secure zone 150 provides useful technical capabilities (such as the crypto engine 121 and decoder 122)—but does not require the fully secure environment that he might use in situations such as secure communications.

At step 245, the supervisor 160 may load the received code into the instruction memory 164, may store any received application data into the data memory 165, and may instruct the secure processor 162 to begin executing the received code.

At step 250, the supervisor 160 may begin waiting for one or more events related to code execution. For example, at transition 252, code running on the secure processor 162 may request the supervisor 160 to switch into full-screen secure mode and obtain access to the whole screen 123 (i.e., without having the “identity image” being shown). In such a case, as described above, at step 254, the supervisor 160 may turn off the indicator 193 to demonstrate that supervisor 160 no longer controls the output to the screen 123 (and therefore that a designated portion of the screen cannot be used to identify the code provider). The supervisor 160 also may instruct the mixer 181 to show only information from the decoder 122 on the screen 123, effectively granting the whole screen 123 to the code running on the secure processor 162.

At transition 255, code running on the secure processor 162 may request the supervisor 160 to switch back into a partial-screen secure mode and redisplay the identity image of the task provider. This may happen, for instance, if a user wished to confirm that the code of the same provider is still running. In this case, at step 256, the supervisor 160 may instruct the mixer 181 to show information from the decoder 122 only on the designated portion of screen 123, while on the other portion the supervisor 160 will begin redisplaying the identity image. The supervisor 160 also may turn on the indicator 193 to assure the user that the displayed is a legitimate identity image.

If, at transition 257, the code execution has finished, the code running on the secure processor 162 may send a notification back to the supervisor 160 notifying it that code execution has finished, and the supervisor 160 may perform certain steps to transition control back to the non-secure zone 152.

In some embodiments it may happen that, as shown at transition 260, code running on the secure processor 162 terminates abnormally (for example, via a secure processor 162 exception).

In this case, at step 270, the supervisor 160 may display a notification message to the user indicating that a secure task has been abnormally terminated and that the system is about to switch to non-secure mode of operation. The method may wait at step 270 until the user confirms that she has viewed this notification message (for example, by pressing a button on the keyboard). This confirmation may be desirable because, otherwise, the user may have the erroneous perception that the secure task is still running after it has actually abnormally terminated. In some embodiments, this notification message may be shown only if the task has changed its state from partial-screen mode to full-screen mode at least once during task execution time.

At step 275, the supervisor 160 may begin a “cleanup” routine and clear all the instruction and data memories 164 and 165 (for example, by zeroing them). At step 280, the supervisor 160 may shut off the indicator 193. Finally, at step 285, the supervisor 160 may transfer control of any I/O devices back to the non-secure zone 152; for example, it might instruct the keyboard switch 194 to process keyboard 192 input through the operating system 111 of the computing device 120, as well as to instruct the mixer 181 to display information which comes from the operating system 111, on screen 123.

Specific types of tasks which may be executed on secure processor 162 within secure zone 150 may include various tasks such as secure chat, media content playback, and so on; examples of some of these tasks are described in U.S. Provisional Application 61/623,861. In addition, other types of tasks such as payment tasks similar to the tasks described in U.S. Provisional Patent Application No. 61/636,201, entitled “Secure Zone for Secure Purchases,” and filed on Apr. 20, 2012, the entirety of which is incorporated herein by reference, may be executed on the secure processor 162. Moreover, other types of tasks such as combined tasks that may comprise ordinary and/or indirect subtasks similar to the tasks described in U.S. Provisional Patent Application No. 61/789,618, entitled “Systems, Methods and Apparatuses for Securely Storing and Providing Payment Information,” and filed on Mar. 15, 2013, the entirety of which is incorporated herein by reference, may also be executed on the secure processor 162.

In one or more embodiments, the non-secure zone 152 and secure zone 150 may be implemented in separate virtual machines executed on a computer processor. FIG. 3 is a block diagram of an exemplary processor 500 according to the present disclosure. The processor 500 may comprise a central processing unit (CPU) 505, a read-only memory (ROM) 520, a secure random access memory (secure RAM) 525, a private key storage 530, a secure hardware timer 535, a certificate storage 540 and a RNG 545. It should be understood that the CPU 505, ROM 520, secure RAM 525, private key storage 530, secure hardware timer 535, certificate storage 540, and RNG 545 are logical components of the processor 500 that may be fabricated on a single silicon chip or on multiple chips packaged together. The processor 500 may have a single physical casing that encloses all its components. In one or more embodiments, the processor 500 may be tamper-resistant and/or may use tamper detection techniques.

The CPU 505 may perform operations normally performed by a computer CPU that can run one or more virtual machines. In some embodiments, the virtual machines may be software implemented virtual machines (for example, using the known paravirtualization technique) and the CPU 505 does not provide any hardware support. In other embodiments, the CPU 505 may be a computer processor that supports virtual machines at the hardware level (e.g., by implementing hardware virtualization techniques known in the art and/or new techniques to be developed in the future). Each of the virtual machines may independently execute instructions as if the virtual machine runs on a computer processor exclusive to itself. For example, each virtual machine may have software running on it, such as, an operating system (like Windows, Linux, etc) with applications, or pieces of software requiring no operating system at all. The virtual machines may be controlled by a hypervisor also executed by the CPU 505. The hypervisor may schedule virtual machines to run and enforce rules related to virtual machine access rights to resources (such as peripheral devices, memory blocks, etc). For example, access to the physical memory may be organized such that software running on one of virtual machines will not be able to access memory used by another virtual machine (e.g., allocated to another virtual machine). In some embodiments, the supervisor 160 may be implemented as one virtual machine, the non-secure zone 152 may be implemented in another virtual machine and each of the tasks to be executed in the secure zone 150 may be executed in separate virtual machines as will be described below. The RNG 545 may be a random number generator similar to the RNG 124 that provides support to cryptographic processes of the exemplary processor 500. In one or more embodiments, the CPU 505 may also perform the functionalities for some components shown on FIG. 1, such as the secure processor 162, image processor 171, crypto engine 121, and decoder 122.

The ROM 520 may be a non-volatile memory and may be configured such that data stored in the ROM 520 may not be accessed and/or modified from outside the processor 500. In one embodiment, the ROM 520 may be fully implemented in hardware to be enclosed within the processor 500. In another embodiment, not shown, the ROM 520 may be implemented as a non-volatile storage external to the processor 500. If implemented as an external storage, the data stored on the ROM may be encrypted and/or authenticated, and the processor 500 may store an encryption key to decrypt and/or authenticate data loaded from the external storage. An exemplary secure non-volatile storage is described in U.S. Provisional Patent Application No. 61/785,388, entitled “Systems, Methods and Apparatuses for Using a Secure Non-Volatile Storage With a Computer Processor,” filed on Mar. 14, 2013, the entirety of which is incorporated herein by reference.

The secure RAM 525 may store data that cannot be accessed and/or modified from outside the processor 500. In some embodiments, the secure RAM 525 may be implemented as a separate memory inside the processor 500. In other embodiments, the secure RAM 525 may be allocated from an existing random access memory already present inside the processor 500 (e.g., an existing L2 or L3 cache). In the latter case, the segment of cache allocated as the secure RAM 525 may be marked as “locked,” that is, the data stored in it should not be exposed outside the processor 500. For example, if the CPU cache is a write-back cache, “locked” may be implemented by permanently marking the cache lines allocated for the secure RAM 525 with two flags: one is the usual “dirty” flag, another is a special “‘locked” flag (which may indicate that such a “locked” cache line should never be written to an external main RAM). In some embodiment, the “locked” flag may imply the “dirty” flag.

The private key storage 530 may be an exemplary implementation of the key storage 167 and may be used for storing one or more unique private keys labeled 532-1 through 532-M (M being a positive integer). In some embodiments, the key storage 530 may be implemented as a separate hardware unit inside the processor 500. In some other embodiments, the key storage 530 may be a part of the ROM 520. In embodiments in which the ROM 520 may be implemented as an external non-volatile storage, the keys stored thereon may be encrypted. If the storage 530 is a separate hardware unit inside the processor 500, in one or more embodiments, the content of the storage may be initialized at the time when the processor 500 is manufactured.

The secure timer 535 may comprise one or more counters which may be used to determine the time elapsed between the occurrence of two events. By way of example and not limitation, a suitable counter may take the form of an oscillator (including, but not limited to a multivibrator) having a known frequency (in which the frequency may be optionally stabilized by using, for example, a quartz crystal resonator) and a digital counter, or any other type of apparatus capable of incrementing a count at a known frequency.

To calculate the time elapsed between two events (e.g., the time the timer 535 was initialized/manufactured or last synchronized with an external trusted time source and the current time), the present state of the counter may be recorded (e.g., in a non-volatile memory within the timer 535) at the first event and again at the second event. Then, in conjunction with the known frequency of the counter, the total number of counter increments occurring between the two events may be used to derive the elapsed time in seconds (or whatever other appropriate time measurement). By way of example and not limitation, a counter operating at 60 ticks/minute could have value 60 at the time of a first event and 180 at the time of a second event. The difference between the first and second events, in ticks, is 120. Thus, at 60/ticks per minute, it can be calculated that 2 minutes elapsed between the two events.

The timer 535 may be implemented so that it cannot be manipulated from outside the processor 500 (but, in some embodiments, time values might be accessible from outside the processor 500 thus implementing read-only access). An exemplary secure timer is described in U.S. Provisional Patent Application No. 61/661,248, entitled “Systems, Methods and Apparatuses for Secure Time Management,” and filed on Jun. 18, 2012, the entirety of which is incorporated herein by reference.

The certificate storage 540 may be an exemplary implementation of the certificate storage 166 and may store one or more certificate chain root keys labeled 542-1 through 542-L (L being a positive integer). The values of such keys may be stored within the processor 500 at the time when the processor 500 is manufactured. The content of this certificate storage 540 may be protected from modifications from outside the processor 500. In some embodiments, the root keys may be kept unmodified during the lifetime of the processor 500. In one of such embodiments, the certificate storage 540 may be, for example, a part of the ROM 520.

In other embodiments, it may be advantageous to periodically update some of such keys. In such embodiments, the certificate storage 540 may be implemented, for example, as an on-chip non-volatile storage (such as EEPROM or battery-powered static RAM) having enough storage for multiple sets of root keys for the processor 500 to switch between different sets of root keys. An exemplary implementation of secure replacement of root certificates within electronic devices is described in U.S. Provisional Patent Application No. 61/663,266, entitled “Systems, Methods and Apparatuses for Securing Root Certificates,” and filed on Jun. 22, 2012, the entirety of which is incorporated herein by reference.

In one embodiment, for example, two sets of root keys may be stored by an embodiment of the processor 500. If five root keys are used for normal operations, for example, the non-volatile storage may have room for storing 10 keys. In addition, the non-volatile storage may contain a one-bit switch to indicate which keyset is currently in use. An exemplary process of updating the root keys may be implemented as follows. At a first stage, the first keyset may contain a set of valid keys in use and the one-bit switch may indicate that the first keyset is in use. Then at a second stage, a key replacement procedure may be processed by the processor 500 to fill a second keyset with a new set of root keys. At the second stage, the one-bit switch may still point to the first keyset and thus, if for any reason processing of the key replacement procedure is not completed, the processor 500 may still function properly using the first keyset and the command may be re-applied if necessary. If the key replacement procedure is completed successfully, the second keyset may have a valid set of root keys. Then at a third stage, the processor 500 may start using the second keyset and the one-bit switch may be changed to indicate that the second keyset is in use.

As described above, the ROM 520 may be implemented as an updatable secure external non-volatile storage and thus, in some embodiments, the certificate storage 540 may be implemented as a part of the ROM 520 in the updatable secure external non-volatile storage. In one such embodiment, the root keys may be updatable as well. For example, initially, a first secure external non-volatile storage may store a set of valid keys that may be encrypted with a symmetric key stored within the processor 500. Then, a certificate replacement message to replace the root key may be received and processed by the processor 500. In processing the certificate replacement message, a second non-volatile storage may be prepared to store a new set of root keys (which may be encrypted with a new symmetric key). In the meantime, the symmetric key stored within the processor 500 may still be the key used to encrypt the root keys stored in the first non-volatile storage. Thus, if for any reason processing of the certificate replacement message is not completed, the processor 500 may still restart with the symmetric key and the key replacement procedure may be re-applied if necessary. After the second non-volatile storage is prepared successfully and its validity is verified, the symmetric key stored within the processor 500 may be changed to the new symmetric key (the one used for encrypting the root keys on the second non-volatile storage).

FIG. 4A is a block diagram showing the exemplary processor 500 in operation according to the present disclosure. The logical structure of the entities running on the CPU 505 is shown in detail on FIG. 4A while other components of the processor 500 (shown in dashed line in FIG. 4A) may be skipped for simplicity. FIG. 4B shows a mapping of some of components on FIG. 1 to components of the CPU 505. As shown in FIG. 4B, the supervisor 160 of FIG. 1 may be implemented as a virtual machine (referred to as VM-S 612), the non-secure zone 152 (with an ordinary operating system and applications running thereon) may be implemented as another virtual machine (referred to as VM-NS 614), and a task to be executed in the secure zone 150 may be executed in yet another virtual machine (referred to as VM-T 616). Further, a segment of physical memory (referred to as NS Bus memory block 618) may be allocated to implement the interface 151 between the secure zone 150 and non-secure zone 152. The instruction memory 164 and data memory 165 may be implemented as memory blocks referred to as instruction memory block 622 and data memory block 624 respectively. In addition, another segment of physical memory may be allocated to be a task interface memory block 620, which may be used for implementing any interface provided by the supervisor 160 to tasks.

The CPU 505 may also run a hypervisor 605 that may control the execution of the virtual machines and allocation of memory blocks. Moreover, the hypervisor 605 may control mapping of peripheral devices to one of the virtual machines. Changing mapping of peripheral devices by the hypervisor 605 may be used to effectively implement the keyboard switch 194 and mixer 181. For example, each peripheral device (e.g., the indicator 193, keyboard 192, screen 123 and communications port 118, etc.) may have its default mappings and the hypervisor 605 may map the peripheral devices (directs their input/output) at the system start according to this default mapping. In one embodiment, the indicator 193 may be always mapped to the VM-S 612 (and if the VM-S 612 doesn't exist at any moment, the indicator 193 may be turned off by the hypervisor 605). Other devices may be mapped to different virtual machines during operation. For example, the keyboard 192 may initially be mapped to the VM-NS 614 and, during operation, the keyboard 192 may be re-mapped to the VM-S 612 and then back to the VM-NS 614. The details of the re-mapping will be described below with respect to exemplary processes to be performed by the processor 500. In one embodiment, the hypervisor 605 may be configured to only grant requests for re-mapping the peripheral devices if they come from the VM-S 612 (and not from any other VM). In some embodiments, the mapping may be supported at least in part by hardware level virtualization techniques, such as an input/output memory management unit (IOMMU). As an example, INTEL's implementation of IOMMU is referred to as Virtualization Technology for Directed I/O (VT-d).

In some embodiments, the VM-S 612 and hypervisor 605 may have their own respective memories (as well as memory allowing for communication between them, if any) mapped to the secure RAM 525 (which may physically reside within the processor 500). The rest of the memory blocks and cache memory of other virtual machines may be mapped to usual RAM (and reside outside of the processor 500).

FIG. 5 is a flow diagram showing an exemplary process 700 of initializing an exemplary processor according to the present disclosure. The exemplary process 700 may illustrate in detail how the virtual machines and the memory blocks of the exemplary processor 500 may be initialized and controlled. At block 702, the exemplary processor 500 may be powered on to initiate a system boot that may start the hypervisor 605. As described above, the hypervisor 605 may be a virtual machine manager that creates and runs virtual machines. In some embodiments, the hypervisor 605 may be loaded from the ROM 520. At block 704, the indicator 193 may be turned off if it's turned on during the system boot. At block 706, the hypervisor 605 may allocate a block of memory as an interface between the secure and non-secure zones. For example, as shown in FIG. 4A, the NS bus memory block 618 may serve as a communication buffer between the virtual machines VM-S 612 and VM-NS 614.

Then the process 700 may proceed to block 708, at which the hypervisor 605 may initialize a first virtual machine (e.g., the VM-S 612) and load the supervisor 160 into the first virtual machine VM-S 612. Then the supervisor 160 may be executed on the first virtual machine VM-S 612 under the control of the hypervisor 605. In one embodiment, the supervisor 160 may be loaded from the ROM 520 to the secure RAM 525 and a reference to the NS bus memory block 618 may be provided to the supervisor 160. Once loaded and started, the supervisor 160 may wait for requests to come through the NS bus memory block 618.

At block 710, the hypervisor 605 may map the indicator 193 to the supervisor 160 running on the first virtual machine VM-S 612. At this point, because the processor 500 may not be executing tasks in a secure mode, the indicator 193 may be kept off by the first virtual machine VM-S 612. At block 712, the hypervisor may initialize a second virtual machine (e.g., the VM-NS 614) and load a non-secure operating system into the second virtual machine VM-NS 614, and start executing the non-secure operating system on the second virtual machine VM-NS 614 under the control of the hypervisor 605.

At block 714, the hypervisor 605 may provide a reference to the NS bus memory block 618 to the VM-NS 614 (for example, this information may be passed to a driver responsible for communicating with the supervisor 160, such driver may reside in the non-secure operating system running within the VM-NS 614) to set up the communication interface between the non-secure operating system on the second virtual machine VM-NS 614 and the supervisor 160 on the first virtual machine VM-S 612. At this stage, the virtual machines for the secure and non-secure zones may be set up and the communication interface between these zones may be ready. The non-secure operating system 111 and applications 112 running on the virtual machine VM-NS 614 may send requests to the supervisor 160 running on the virtual machine VM-S 612 via the communication interface NS bus memory block 618 (for example, via the driver described above). It should be noted that the initialization and loading of the virtual machines VM-S 612 and VM-NS 614 may be performed in any sequence. In another embodiment, the VM-NS 614 may be initialized and loaded first and the VM-S 612 may be initialized subsequently, or both VM-NS 614 and VM-S 612 may be initialized in parallel.

FIG. 6 illustrates an exemplary process 800 of executing a task using the exemplary processor 500 according to the present disclosure. The process 800 may start at block 802, at which a request to load and execute a task may be sent from the virtual machine VM-NS 614 that executes the non-secure zone 152 to the virtual machine VM-S 612 that executes the supervisor 160. In some embodiments, such a request may include one or more blocks of data sent over the NS Bus memory block 618. Then at block 804, a request may be sent from the virtual machine VM-S 612 to the hypervisor 605 for allocation of three memory blocks that are needed for executing a task: instruction memory block 622, data memory block 624, and task interface memory block 620. In some embodiments, the hypervisor 605 may allocate these memory blocks as a single contiguous memory block or dispersed memory blocks. At block 806, the virtual machine VM-S 612 may load the task and prepare to execute it. In one embodiment, as described above with respect to FIG. 2, in preparing to execute the task, the VM-S 612 may decrypt the task (if applicable), verify the task signatures, clean the memory blocks 620, 622, and 624 (for example, by zeroing them), and load the task code to the instruction memory block 622 and task data to the data memory block 624.

At block 808, the VM-S 612 may send a request to the hypervisor 605 to re-map certain peripheral devices. For example, the virtual machine VM-S 612 may request the hypervisor 605 to re-map the keyboard 192 and screen 123 to the virtual machine VM-S 612. Before or after such re-mapping, in some embodiments, the virtual machine VM-S 612 may save the state of some or all remapped peripheral devices. At block 810, the indicator 193 may be turned on and other steps related to task initialization may be performed. For example, the virtual machine VM-S 612 may turn on the indicator 193 and performs other steps related to task initialization as described with respect to the exemplary method shown in FIG. 2. At block 812, the hypervisor 605 may be requested to create a virtual machine for the task to be executed thereon. For example, the virtual machine VM-S 612 may request the hypervisor 605 create a virtual machine VM-T 616 using the image residing in the memory blocks 622 and 624. Additionally, the task interface memory block 620 may be used as a memory buffer to implement an interface between the task and the supervisor. In some embodiments, this request may include a virtual address where the memory block 620 may be mapped within the newly created VM-T 616.

Once the request for task execution is sent out, at block 814, the virtual machine VM-S 612 may wait for task related events. For example, the VM-S 612 may wait for requests coming though NS bus memory block 618 and task interface memory block 620 from VM-NS 614 and VM-T 616 respectively, and any input data from the peripheral devices.

At block 816, the process 800 may execute the task on the newly created virtual machine VM-T 616 using the memory blocks 622 and 624. In one embodiment, the virtual machine VM-T 616 may have permissions to access only the memory blocks 622, 624, and 620 to execute the task. In one non-limiting embodiment, permissions granted to the VM-T 614 to access memory blocks 620 and 624 may disallow code execution (that is, the code can be executed only if it is located in the block 622, which may be implemented, for example, by using NX bit or XN bit mentioned above) to ensure code and data separation.

At block 818, the supervisor 160 on the VM-S 612 may process the task related events. For example, once the task may be loaded into the virtual machine VM-T 616 and start executing, the VM-S 612 may wait for task related events. The task related events may include, for example, Application Programming Interface (API) calls from the task being executed and notifications from any hardware devices (e.g., the keyboard 192). The API calls may include calls from the VM-T 616 (via the interface based on the task interface memory block 620). In one embodiment, notifications from the hardware devices may be redirected via the communication interface based on the task interface memory block 620 to the VM-T 616.

At block 820, the supervisor 160 on the VM-S 612 may be notified about the termination of the virtual machine VM-T 616 that executes the task. For example, the hypervisor 605 may monitor the execution of all virtual machines and may notify the VM-S 612 about the termination of execution in the VM-T 616. In some embodiments, this notification may contain the reason for the termination (for example, using exit code, error code, or exception code).

At block 822, the process 800 may perform cleanup after the termination of the task virtual machine VM-T 616. For example, upon receiving the notification about the termination of the VM-T 616, the VM-S 612 may turn off the indicator 193 and request the hypervisor 605 to re-map other peripheral devices to the VM-NS 614. Before or after such re-mapping, in some embodiments, the virtual machine VM-S 612 may restore the state of some or all remapped peripheral devices to values saved at the block 808. In some embodiments, the hypervisor 605 may clean the memory blocks 622 and 624. In other embodiments, the hypervisor 605 may map these memory blocks to the VM-S 612 so that the VM-S 612 may perform the cleanup of these memory blocks (for example, by zeroing them).

In some embodiments, the virtual machine VM-S 612 for the supervisor 160 may be created “on demand.” In one such embodiment, the virtual machine VM-S 612 for the supervisor 160 may be created only when the virtual machine VM-NS 614 for the non-secure zone 152 tries to initiate a communication with the supervisor 160 via the NS Bus memory block 618. For example, when the VM-NS 614 needs to load a task (or otherwise communicate with the supervisor 160), it may send a message to the hypervisor 605 (for example, using a predefined message intended for this purpose). As a result of this message, the hypervisor 605 may load the supervisor 160 to a newly created VM-S 612 and allocate the memory block 618. Once the VM-S 612 is loaded and the memory block 618 is ready, the hypervisor 605 may provide a reference to the NS Bus memory block 618 to the VM-NS 614 and the task can be loaded as described above. When the task is terminated and unloaded (at block 822), the VM-S 612 may remain active (waiting for requests), or the hypervisor 605 may select to unload it. In the latter case, the hypervisor 605 may ensure that the indicator 193 is turned off.

There may be a number of ways to implement communication via the interfaces based on the memory blocks 618 and 620. In one embodiment, a virtual machine (e.g., the VM-NS 614) initiating the communication (sending a request, calling an API, etc) may load associated data to the relevant memory block (e.g., NS Bus memory block 618), and then send a notification to the hypervisor 605 to indicate that it wants to communicate the data already loaded into the relevant memory block to a receiving virtual machine (in the above example, to the VM-S 612). Then the hypervisor 605 may forward this notification to the receiving virtual machine (e.g., the VM-S 612). If necessary, the hypervisor 605 may also schedule the receiving virtual machine so that the receiving virtual machine may be able to process the request. In addition, in some embodiments, the hypervisor 605 may re-map appropriate memory space and enforce a rule that after such a request is formed, only the receiving virtual machine may have access to the relevant memory block (and the virtual machine sending the request may not modify its request anymore). The notification may include a reference to the calling virtual machine (e.g., VM-NS 614) and/or to the relevant memory block to be used for communication (e.g., NS Bus memory block 618). Finally, after being notified by the hypervisor 605, the receiving virtual machine (e.g., the VM-S 612) may receive the notification from the hypervisor 605, read a corresponding buffer (e.g., the NS Bus memory block 618), and process the call or notification.

In another embodiment, to implement communication via the interfaces based on memory blocks 618 and 620, a virtual machine initiating a communication (for example, the VM-NS 614) may first load data relevant to the request to a relevant memory block (for example, the NS Bus memory block 618), and then change a predefined area of memory within that memory block (e.g., a counter value stored in that area). A virtual machine waiting for a notification (e.g. the VM-S 612) may periodically check for changes of that predefined area, and if changes are detected, assume that the request has been sent and process the data related to the request.

As described above with respect to FIG. 1, in some cases the screen 123 may be used simultaneously by the supervisor 160 and tasks being executed in the secure zone 150, or by tasks being executed in the secure zone 150 and the operating system running in the non-secure zone 152. In all such cases, the portion of the screen generated by different entities (such as the supervisor 160, secure tasks, and non-secure system 152) may be protected against access by other entities. Similarly, for the virtual machines VM-S 612, VM-NS 614, and VM-T 616 (representing, correspondingly, the supervisor 160, non-secure system 152, and a task), the screen output generated by either VM-S 612, VM-NS 614, or VM-T 616 may be protected against access by another virtual machine. To implement this functionality, in one embodiment, when some secure data needs to be shown on the screen 123 (for example, when a task is running), the VM-S 612 may take control over the screen 123 (e.g., at block 808), and each of the VM-NS 614 and VM-T 616 may prepare their screen data and send the prepared data to the VM-S 612 (using, for instance, corresponding communication interfaces based on the memory blocks 618 and 620 respectively) for the screen data being sent to the screen 123. Since neither virtual machines VM-NS 614 or VM-T 416 has direct access to the screen 123 at any time, none of them may access a portion of the screen unless that access is permitted by the supervisor 160.

In the above embodiment, the amount of data related to the screen 123 and communicated through the corresponding interfaces may be significant, and may require a lot of system resources for processing. To mitigate this problem, in some other embodiments, a video card (not shown) of device 120 may be implemented in a way to appear as three separate devices: (a) a secure screen device; (b) an insecure screen device; and (c) a device which tells which part of the screen is controlled by (a) or (b). The devices (a) and (b) may be configured to not exchange any information between them. In the simplest form, the device (c) may define a set of rectangles controlled by the secure device (a). In one embodiment, the devices (a) and (b) may have equal capabilities. In other embodiments, the capabilities of such devices may differ (e.g., insecure device (b) may support 3D and/or video decoding, while secure device (a) may only support static images). Further, in some other embodiments, the secure device (a) may support “an alpha-channel” so an image passed to the secure device (a) may overlay images/videos/3D pictures passed to insecure device (b), which may be useful in some specific scenarios, like overlaying gaming status information over insecure 3D picture, etc. In embodiments where such a video card (with three devices) is used, the secure device (a) may be, for example, configured by the hypervisor (for example, using IOMMU) to be controlled by VM-T 616, the insecure device (b) may be controlled by VM-NS 614, and the device (c) may be controlled by VM-S 612.

As described above, FIG. 4A illustrates an exemplary processor 500 that has the hypervisor 605 and separate virtual machines VM-S 612, VM-NS 614, and VM-T 616. It is to be understood that FIG. 4A is an exemplary embodiment and that in some embodiments the separation of components may be different. For example, the hypervisor 605 and the VM-S 612 may be combined so that functionalities of both of them may be performed by one hypervisor. In other words, a single hypervisor may implement both functionality of the hypervisor 605 (required to run virtual machines) and functionality of the supervisor 160. In this case, the single hypervisor may use the secure RAM 525 for all operations, and the secure RAM 525 may not be mapped to any of the virtual machines. In some other embodiments, the VM-S 612 and VM-T 616 may be combined into a single virtual machine so that the supervisor 160 logic and tasks may be performed within the same virtual machine. In such embodiments, when a task is to be loaded, the VM-S 612 may request the hypervisor 605 for the memory blocks 622, 624, and 620. Alternatively, the VM-S 612 may allocate some or all of such memory blocks within its own memory. Then the task may be loaded and executed as a separate process run by a secure operating system running within VM-S 612 (with the secure operating system implementing the supervisor's logic).

In addition to executing tasks as described above, embodiments of the present disclosure may also execute subtasks, for example, as described in U.S. Provisional Application 61/636,201. In addition, indirect subtasks, such as an ICC indirect subtask described in U.S. Provisional Application No. 61/789,618, may also be executed by embodiments of the present disclosure. In general, the subtasks may have different permissions and may not be able to access memory of the calling task (except a memory block specially intended as shared). Also, the calling task may be suspended when the called subtask is executed. In one embodiment, in which a task may be executed in a separate virtual machine as described above, to enforce required memory separation, a subtask may be executed in its own virtual machine as if it were a separate task. FIG. 7 is a flow diagram showing an exemplary process 900 of executing a subtask using an exemplary processor according to the present disclosure. The process 900 may start at block 902, at which the supervisor 160 running on the virtual machine VM-S 612 may receive a request from a task running on the virtual machine VM-T 616 to load a subtask (for example, via the interface based on the task interface memory block 620). The request may contain the subtask to be executed (or, alternatively, an identifier of the subtask which is already known to the supervisor, for example, as a part of loading task process) and the reference to a memory block to be used for data shared between the task and the subtask (such memory block may be implemented similar to memory block used for the task interface memory block 620).

Then the process 900 may proceed to block 904, at which the task (running on the VM-T 616) may be suspended (for example, VM-T 616 may not receive further time slices from the hypervisor until it is resumed in block 908). Then at block 906, the subtask may be executed as a separate task. In some embodiments, the processor 500 may treat the subtask as a regular separate task and may execute the exemplary process 800 in its entirety (or in substantial part) at block 906. For example, another virtual machine may be initialized, the subtask may be verified and loaded into the newly created virtual machine, executed, and terminated as described above with respect to blocks 802-822. In one embodiment, the memory block to be used for data sharing may also be mapped to this newly created virtual machine. In some embodiments, an executing subtask virtual machine may have its access to peripheral devices restricted (for example, by the hypervisor 605 as instructed by the supervisor running within VM-S 612) according to the subtask permissions (for example, as mentioned in the subtask certificate). It should be noted that in some cases, subtask permissions may be narrower than task permissions, and in some cases, subtask permissions may be broader than task permissions. When the execution of the subtask is terminated, at block 908, the execution of the task in the VM-T 616 may be resumed.

The exemplary process 900 illustrates an embodiment in which the supervisor 160 and a task may be executed in separate virtual machines. In another embodiment (for example, if the supervisor and task are running in the same virtual machine as described above), to enforce the required memory separation, a subtask may be executed as a separate process. In this embodiment, to execute a subtask, the process running the calling task may be suspended, the subtask may be executed as a separate process, and then the task may be resumed. In this embodiment, the memory separation may be enforced by the secure operating system that implements the supervisor.

The processor 500 may utilize various virtualization technologies including hardware virtualization technologies developed by CPU manufacturers. For example, the processor 500 may utilize technologies such as AMD-V® and Intel VT-x®. Additionally, to ensure device separation between different virtual machines, the processor 500 may utilize the IOMMU functionality implemented in INTEL or AMD processors.

Alternatively, the processor 500 may be implemented over an ARM® TRUSTZONE®. It should be noted that the TRUSTZONE implementation may be equivalent to having only two virtual machines (“secure world” and “normal world”, plus monitor mode which is functionally similar to the hypervisor) on a single processor. As one example of implementing the processor 500 on TRUSTZONE, the VM-NS 614 may be in the TRUSTZONE “normal world,” and the VM-S 612 may be combined either with the hypervisor 605 under the TRUSTZONE “monitor mode,” or combined with the VM-T 616 under the TRUSTZONE “secure world” (running tasks as separate processes within the VM-S 612). In another embodiment, for CPUs based on the ARM architecture, the ARM virtualization extensions may be used in a manner similar to the x86 virtualization technologies.

In some embodiments, the processor 500 may support two modes of system boot: secure boot mode and insecure boot mode. In the secure boot mode, the system may behave as described above, allowing to boot the hypervisor only from ROM 520. In the insecure boot mode, the processor 500 may allow a non-secure hypervisor or a non-secure operating system to run (i.e. the processor 500 may be allowed to boot from an arbitrary source), while ensuring that there is no access from this non-secure hypervisor (or non-secure operating system) to any (or some of) security features described above. For example, in the insecure mode, the indicator 193 may always be kept “off”, and there may be no access (e.g., read or write (modification)) to data stored in the ROM 520, private key storage 530, or certificate storage 540. Also, in the insecure mode, the secure timer 535 cannot be reset or somehow modified (but in some embodiments, it may be allowed to be read).

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. An apparatus, comprising:
a screen; and
a computer processor coupled to the screen and being configured to:
initialize a hypervisor;
establish a first and second virtual machines under control of the hypervisor;
execute code for a non-secure zone on the second virtual machine; and
execute code for a secure zone on the first virtual machine, wherein the code for the secure zone is configured to initiate executing a task and to assume control over an output to the screen while the apparatus is operating in a secure mode and to transfer control over the output to the screen to the non-secure zone while the apparatus is operating in a non-secure mode;
wherein for the secure zone to assume control over the output to the screen, the hypervisor is configured to grant a first request from the secure zone to assume control over the output to the screen;
wherein for the secure zone to transfer control over the output to the screen to the non-secure zone, the hypervisor is configured to grant a second request from the secure zone to transfer control over the output to the screen.

2. The apparatus of claim 1, wherein for secure zone to initiate executing the task the computer processor is further configured to:
establish a third virtual machine under control of the hypervisor;
execute the task in the third virtual machine.

3. The apparatus of claim 2, wherein the computer processor is further configured to load and execute a subtask of the task in a separate virtual machine.

4. The apparatus of claim 2, wherein the code for the secure zone is configured to process task related events including Application Programming Interface (API) calls from the task being executed and notifications from any peripheral devices.

5. The apparatus of claim 1, wherein the hypervisor is configured to establish an interface between the non-secure zone and the secure zone, wherein the secure zone receives the task from the non-secure zone through the interface,

6. The apparatus of claim 5, wherein to implement the interface the computer processor is further configured to:
allocate a block of memory from a random access memory (RAM) coupled to the computer processor; and
grant access to the block of memory to both the secure zone and non-secure zone.

7. The apparatus of claim 1, wherein the code for the non-secure zone comprises an operating system and at least one application to be executed in the non-secure mode,

8. The apparatus of claim 7, wherein the hypervisor is configured to load the operating system to the second virtual machine.

9. The apparatus of claim 1, further comprising an indicator coupled to the computer processor, wherein the hypervisor is configured to map the indicator to the secure zone while the apparatus is operating in the secure mode.

10. The apparatus of claim 9, wherein the secure zone is configured to turn off the indicator while the apparatus is operating in the non-secure mode.

11. The apparatus of claim 1, further comprising a video card coupled to the screen, wherein the video card is implemented to appear as three separate devices: (a) a secure screen device; (b) an insecure screen device; and (c) a device which tells which part of the screen is controlled by (a) or (b).

12. The apparatus of claim 1, wherein the computer processor is implemented with hardware level support for virtual machines.

13. A method of operating a computer processor in an apparatus, comprising:
initializing a hypervisor;
establishing a first and second virtual machines under control of the hypervisor;
executing code for a non-secure zone on the second virtual machine; and
executing code for a secure zone on the first virtual machine, wherein the code for the secure zone is configured to initiate executing a task and to assume control over an output to a screen coupled to the computer processor while the apparatus is operating in a secure mode and to transfer control over the output to the screen to the non-secure zone while the apparatus is operating in a non-secure mode;
wherein for the secure zone to assume control over the output to the screen, the hypervisor is configured to grant a first request from the secure zone to assume control over the output to the screen; and
wherein for the secure zone to transfer control over the output to the screen to the non-secure zone, the hypervisor is configured to grant a second request from the secure zone to transfer control over the output to the screen.

14. The method of claim 13, further comprising:
establishing a third virtual machine under control of the hypervisor;
executing the task in the third virtual machine.

15. The method of claim 14, further comprising loading and executing a subtask of the task in a separate virtual machine.

16. The method of claim 14, further comprising processing task related events including Application Programming Interface (API) calls from the task being executed and notifications from any peripheral devices by the code for the secure zone.

17. The method of claim 13, further comprising:
establishing an interface between the non-secure zone and the secure zone.

18. The method of claim 17, further comprising:
allocating a block of memory from a random access memory (RAM) coupled to the computer processor; and
granting access to the block of memory to both the secure zone and non-secure zone.

19. The method of claim 18, further comprising:
receiving the task at the secure zone from the non-secure zone through the interface.

20. The method of claim 13, wherein the code for the non-secure zone comprises an operating system and at least one application to be executed in the non-secure mode.

21. The method of claim 20, wherein the hypervisor is configured to load the operating system to the second virtual machine.

22. The method of claim 13, further comprising mapping an indicator coupled to the computer processor to the secure zone while the apparatus is operating in the secure mode.

23. The method of claim 22, further comprising turning off the indicator while the apparatus is operating in the non-secure mode.

24. The method of claim 13, wherein the apparatus comprises a video card coupled to the screen, and the video card is implemented to appear as three separate devices: (a) a secure screen device; (b) an insecure screen device; and (c) a device which tells which part of the screen is controlled by (a) or (b).

25. The method of claim 13, wherein the computer processor is implemented with hardware level support for virtual machines.
